(19) United States
(12) Patent Application Publication
(10) Pub. No.: US 2008/0275770 A1
(43) Pub. Date: Nov. 6, 2008

(54) Publisher advertisement return on investment optimization

(75) Inventor: Brendan James Kitts, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/799,192

(22) Filed: May 1, 2007

(51) Int. Cl. G06Q 30/00

(52) U.S. Cl. 705/14

(57) ABSTRACT

An advertising network can provide mechanisms to publishers with which the publishers can influence the relevance of the advertisements provided by the advertising network for display with the publisher's web sites. Such mechanisms include bid boosts, discounts and rank boosts, each of which, either directly or indirectly, can increase or decrease the likelihood that an advertising network will provide a advertisement, targeted by these mechanisms, to the publisher's web pages. Each of these mechanisms also enable the publisher to sacrifice ad-generated revenue for the sake of more relevant advertisements. The advertising network can also provide an interface through which a publisher can access these mechanisms. Such an interface can comprise a predictive analysis based on information gathered from the publisher's web sites, that can enable the publisher to visualize the effect of these mechanisms on factors such as ad-generated revenue and visitor return rates.

### BACKGROUND

The core of the World Wide Web (WWW) comprises several billion interlinked web pages which are visited by over a billion people. As such, web pages, especially popular web pages, provide a powerful advertising medium. Traditionally, the financial aspects of web page advertising have based, at least in part, on the number of “click-throughs” occurring through the ad. In web advertising parlance, a “click-through” required not just that a visitor to the web page saw and read the ad, but that they actually clicked on the ad, thereby suspending their visit to the web page and instead visiting the advertiser's web page, or whatever other web page may have been linked with the advertisement.

To avoid the exponential complexity of each web site publisher independently negotiating advertising rates with each advertiser, advertising networks were created to serve as a clearinghouse for web-based advertisements. An advertising network would, therefore, receive advertisements from multiple advertisers and then provide those ads to multiple web pages created by multiple publishers. Traditionally, web pages requested ads through scripts on the web page that would be interpreted and executed by the web browser when the web page was received by the web browser. More specifically, the scripts on the web page could instruct the web browser, while loading the web page, to also contact the advertising network and obtain from the ad network one or more ads that would get displayed in predetermined locations on the web page.

In addition to aggregating advertisements and providing them on request to complete the rendering of web pages, the advertising network also traditionally negotiated advertising rates with both the advertisers and publishers. The amount paid, by an advertiser, to the advertising network, for each click-through that an ad generated was known as the advertiser's “bid.” Some percentage of the bid would be forwarded, by the advertising network, to the publisher, and the rest would be kept by the ad network.

To maximize their profitability, advertising networks traditionally gave priority to those advertisements that had the highest bids. However, advertisements that were not relevant to the users to whom they were displayed generated few click-throughs and, consequently, little revenue. To better correlate advertisements to the interests of the users they were displayed to, advertising networks provided mechanisms by which advertisers could associate their advertisements with key words that could be used to match the products or services advertised to the content of the web page on which the advertisement would be displayed.

To set keywords, bid values, or other relevant information, advertisers were traditionally offered, by the advertising network, an interface that enabled them to access the relevant, advertiser-specific information maintained by the advertising network. Such an interface also traditionally enabled the advertiser to obtain more detailed information that the advertiser could use as the foundation for economic analysis of their advertisements and their web-based advertising program.

### SUMMARY

A publisher interface can be provided by an advertising network to enable publishers to exert control over the advertisements they receive, even if such control can negatively impact the revenue received by the advertising network. In one embodiment, a web page publisher can be allowed to select advertisements that are more relevant to that publisher's web pages, even if such advertisements may have lower bids than other advertisements that may be less relevant to the publisher's web pages. The balance between advertisements that have high bids, and thus result in greater revenue, and advertisements that are more relevant to the publisher's web pages can be selected through a simple user interface control, such as a slider bar. Alternatively, the publisher can influence, in a more precise manner, the advertising network's selection of advertisements to be displayed on the publisher's web pages.

In one embodiment, the advertising network can provide more precise publisher control through a “bid boost” mechanism, whereby the amount actually charged to, and paid by, an advertiser for a clickthrough is less than the amount bid by the advertiser. By reducing the advertiser's costs for the targeted advertisements, the advertiser's return per unit of cost, or “return on investment” (ROI) for those advertisements is increased. This increase should cause rational advertisers to increase the bid of the targeted advertisements in an effort to generate even more return. Such an increase in the bid can cause the advertising network to assign a greater priority to the targeted advertisements, thereby increasing the frequency with which those ads are displayed on the publisher's web site.

In another embodiment, the advertising network can provide more precise publisher control through a “discount” mechanism, whereby the share of the revenue received by the advertising network, from the advertiser, that is paid to the publisher is decreased. Such a decrease in the payout to the publisher causes an increase in the income to the advertising network from the targeted advertisements. Such an increase can cause the advertising network to assign a greater priority to the targeted advertisements, thereby increasing the frequency with which those ads are displayed on the publisher's web site.

In a further embodiment, the advertising network can provide more precise publisher control through a “rank boost” mechanism, whereby the rank assigned to a particular advertisement by the advertising network can be increased by the publisher. Such an increase in the rank of an advertisement can directly increase the frequency with which that advertisement is displayed on the publisher's web site.

In one embodiment, a bid boost, discount, or rank boost, or some combination thereof, can be applied on a per-advertisement basis. The advertising network can provide an interface by which the publisher can view various advertisements hosted by the ad network, and can set a bid boost, discount, rank boost, or some combination therefore, for each ad, or only for selected ads. The default values of the bid boost, discount and rank boost for each advertisement can be such that the failure, by the publisher, to manually set such values can result in advertising network continuing to rank that advertisement according to its revenue generation. Alternatively, the default values of the bid boost, discount and rank boost for each advertisement can be such that the publisher's failure to manually set such values can result in advertising network ranking that advertisement according to an overall balance between relevance and revenue generation set by the publisher.

In an alternative embodiment, rather than applying bid boosts, discounts, rank boosts, or some combination thereof, on a per-advertisement basis, they could be applied by the publisher on different basis. For example, publishers could be allowed to apply bid boosts, discounts and rank boosts on a per-advertiser basis, a per-keyword basis, a per category-basis, a per site-basis, or any other such basis that can enable the publisher to more accurately specify their preferences. Such options can be offered to the publisher through an interface provided by the advertising network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a diagram of an exemplary system that provides context for the described functionality;

FIG. 2 is a block diagram of an exemplary computing device;

FIG. 3 is an illustration of an exemplary of a web page having space provisions for advertisements;

FIG. 4 is a flow diagram illustrating an exemplary presentation of advertisements in web pages;

FIG. 5 is a flowchart illustrating an exemplary process for providing advertisements to a web page;

FIG. 6 is a flowchart illustrating an exemplary process for providing publisher influence over displayed advertisements;

FIG. 7 is an exemplary user interface for providing publisher influence over displayed advertisements; and

FIG. 8 is a flow diagram illustrating an exemplary effect of publisher influence over displayed advertisements.

### DETAILED DESCRIPTION

The following description relates to providing publisher influence over the advertisements displayed on that publisher's web pages by an advertising network. The advertising network can provide the publisher with an interface by which the publisher can, in one embodiment, simply rebalance the weighting between advertisements that generate the most revenue, and advertisements that are most relevant, given the content of the publisher's web page on which the ad is to be displayed. In an alternative embodiment, the interface provided by advertising network to the publisher can comprise more detailed controls that can more precisely influence the advertisements displayed on that publisher's web pages by the ad network. Such more detailed controls can include a “bid boost” that can be used by the publisher to decrease the amount charged to, and paid by, the advertiser. Likewise, a “discount” can be used by the publisher to decrease the share of the advertiser's payment that is provided to the publisher, and thereby increase the share of the advertiser's payment that is kept by the advertising network. Additionally, a “rank boost” can be used by the publisher to directly increase the priority of one or more advertisements, as ranked by the advertising network. These more detailed controls can be exerted on individual advertisements or on groups of advertisements sharing a common element, such as a keyword or advertiser.

The techniques described herein focus on the collection of information to be presented to a publisher that can aid that publisher in determining how to influence the advertisements provided by an advertising network for display on that publisher's web pages. The techniques described herein further focus on the presentation of such collected information to the publisher and on the presentation, to the publisher, of controls that can be used by the publisher to influence which advertisements are provided by the advertising network for display on that publisher's web pages. While the techniques below are described with reference to web-based advertising, the concepts presented are equally applicable to other forms of electronic advertising, such as, for example, ad-sponsored software where electronic advertisements are displayed within the context of stand-alone software directed to some useful task beyond the mere display of ads. Thus, while the below descriptions reference a “web browser” and “web pages,” the described mechanisms are communication and display format agnostic and are not intended to be limited to only environments based on the HyperText Transfer Protocol (HTTP) and the HyperText Markup Language (HTML).

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing devices, as the mechanisms may also be practiced in distributed computing environments where tasks are performed by remote processing devices that are linked through a communications network. In a distributed computing environment, program modules may be located in both local and remote memory storage devices.

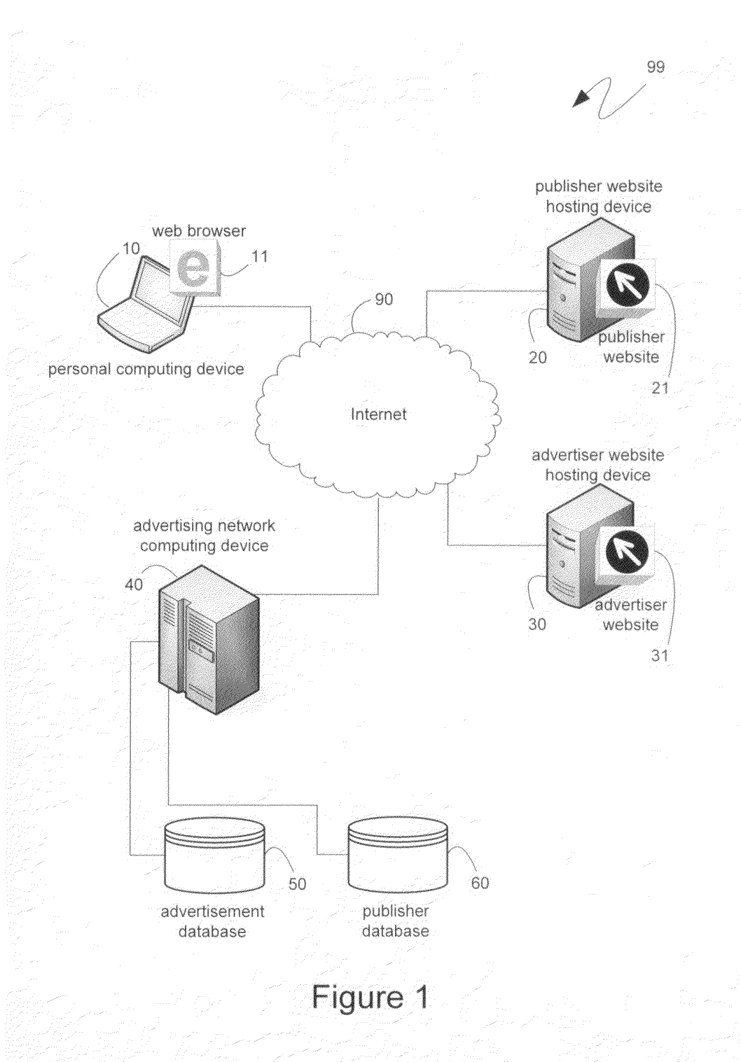

With reference to FIG. 1, an exemplary system 99 is illustrated, providing context for the descriptions below. The exemplary system 99 can be part of the Internet 90, as illustrated, though the reference to the Internet is strictly an example and is not intended to limit the descriptions to Internet protocols, such as the Transmission Control Protocol (TCP), the Internet Protocol (IP), or any other Internet-specific technology. Exemplary system 99 includes a personal computing device 10 and website hosting computing devices 20 and 30 connected to the Internet 90. Each of the website hosting devices 20 and 30 hosts a website 21 and 31, respectively, which can be browsed from the personal computing device 10 with a web browser 11. More precisely, the various web pages of websites 21 and 31 can be read and displayed by web browser 11. As will be known by those skilled in the art, the collection of websites hosted by computing devices connected to the Internet 90 is commonly referred to as the World Wide Web. However, as with the reference to the Internet itself, the reference to the World Wide Web is strictly exemplary and is not intended to limit the descriptions to HTTP, HTML, or any other World Wide Web-specific technology.

The website hosting device 20 is a publisher website hosting device which hosts one or more web sites created or maintained by the publisher, such as the publisher website 21. The website hosting device 30 is an advertiser website hosting device which hosts an advertiser website 31. Typically, the advertiser website 31 comprises one or more web pages providing a detailed description of products or services offered by the advertiser. The publisher website 31 comprises one or more web pages which can provide informational content accessed by visitors to the publisher website and which can also provide advertisements of the advertiser's products or services. Such advertisements can provide an initial amount of information regarding the advertiser's products or services, and can link to the advertiser website 31 to provide additional information. A visitor to the publisher website 21 who is so intrigued with a displayed advertisement that they select the advertisement and visit the advertiser website 31 is said to have generated a “click-through” on that advertisement.

Rather than communicating directly with one another to enable the publisher website 21 to host advertisements referencing the advertiser website 31, both the publisher and the advertiser can use an advertising network. Thus, FIG. 1 includes an advertising network computing device 40 which hosts an advertisement database 50, comprising one or more advertisements for display on a web page, and a publisher database 60 comprising information regarding those publishers that use the advertising network to receive advertisements for display on their web pages. In one embodiment, the advertiser provides one or more advertisements to the advertising network computing device 40 for storage in the advertisement database 50. The advertiser also provides a “bid” for each of the one or more advertisements, thereby indicating the amount of money the advertiser will pay, to the advertising network, for a predefined event relating to the presentation of the ad, such as the display of the ad on a web page, or, more typically, a click-through occurring on the ad. The advertiser's bid can likewise be stored in the advertisement database 50.

The publisher database 60, connected to the advertising network computing device 40, comprises information relevant to each of the publishers that have created one or more web pages, such as the web pages of the publisher website 21, which instruct the browser 11 to obtain advertisements from the advertising network computing device for display with the web page. In one embodiment, the advertiser network computing device 40 provides an interface through which a publisher can obtain associated information from the publisher database 60 and can, based on such information, among other factors, set one or more parameters that can influence the advertisements that are provided to the browser 11 when reading a web page from the publisher website 21.

The information stored in the publisher database 60 can, in part, be originally collected by the publisher website hosting device 20 and can be provided to the advertising network computing device 40 upon request. Subsequently, the advertising network computing device 40 can aggregate the information received and present it to the publisher in a manner that informs the publisher of the revenue received by the publisher from the advertising network and further informs the publisher of the perceived relevance, to the content of the publisher's web pages, of the advertisements provided by the ad network. Based, at least in part, on such information, the publisher can set one or more parameters directed to balancing the display of advertisements that maximize publisher advertising revenue, and the display of ads that are most relevant to the visitors of the publisher's web pages. Such parameters can, then, themselves be stored in the publisher database 60, or other appropriate storage location accessible by the advertising network computing device 40.

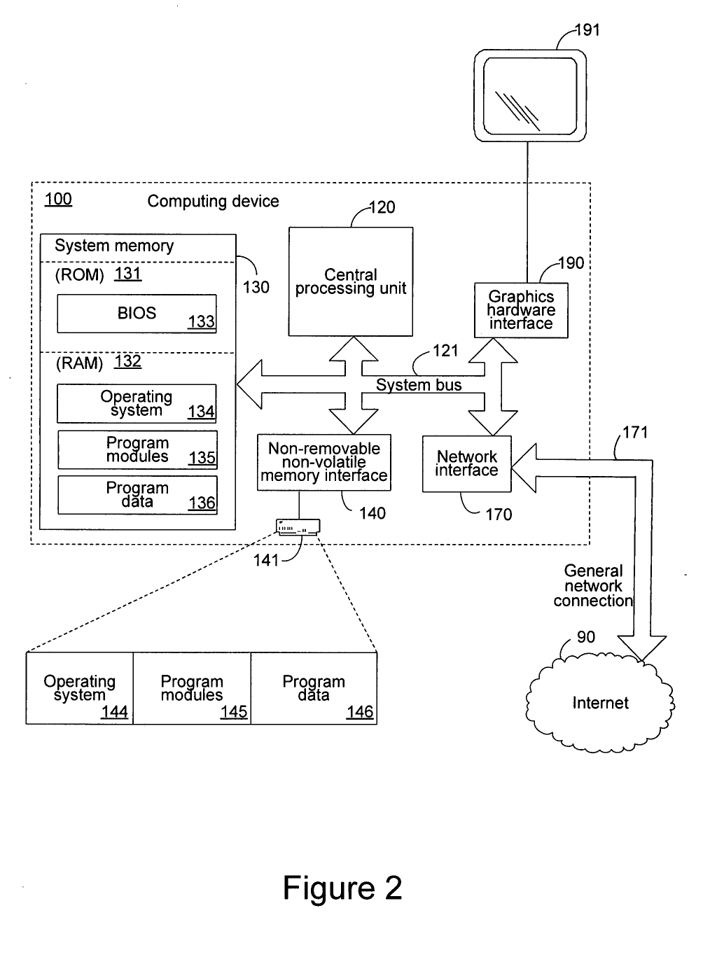

The advertising network computing device 40, the website hosting device 20 and 30, and the personal computing device 10 can each be any type of computing device. Further detail regarding these computing devices of FIG. 1 is provided with reference to an exemplary computing device 100 of FIG. 2. The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include the Peripheral Component Interconnect (PCI) bus and various higher speed versions thereof, the Industry Standard Architecture (ISA) bus and Enhanced ISA (EISA) bus, the Micro Channel Architecture (MCA) bus, and the Video Electronics Standards Associate (VESA) bus. The computing device 100 can optionally include graphics hardware, including, but not limited to, a graphics hardware interface 190 and a display device 191.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, other program modules 135, and program data 136.

The computing device 100 may also include other removable/non-removable, volatile/nonvolatile computer storage media. By way of example only, FIG. 2 illustrates a hard disk drive 141 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers hereto illustrate that, at a minimum, they are different copies.

Of relevance to the descriptions below, the computing device 100 may operate in a networked environment using logical connections to one or more remote computers. For simplicity of illustration, and in conformance with the exemplary system 99 of FIG. 1, the computing device 100 is shown in FIG. 2 to be connected to the Internet 90. However, the computing device 100 is not limited to any particular network or networking protocols. The logical connection depicted in FIG. 2 is a general network connection 171 that can be a local area network (LAN), a wide area network (WAN) or other networks. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

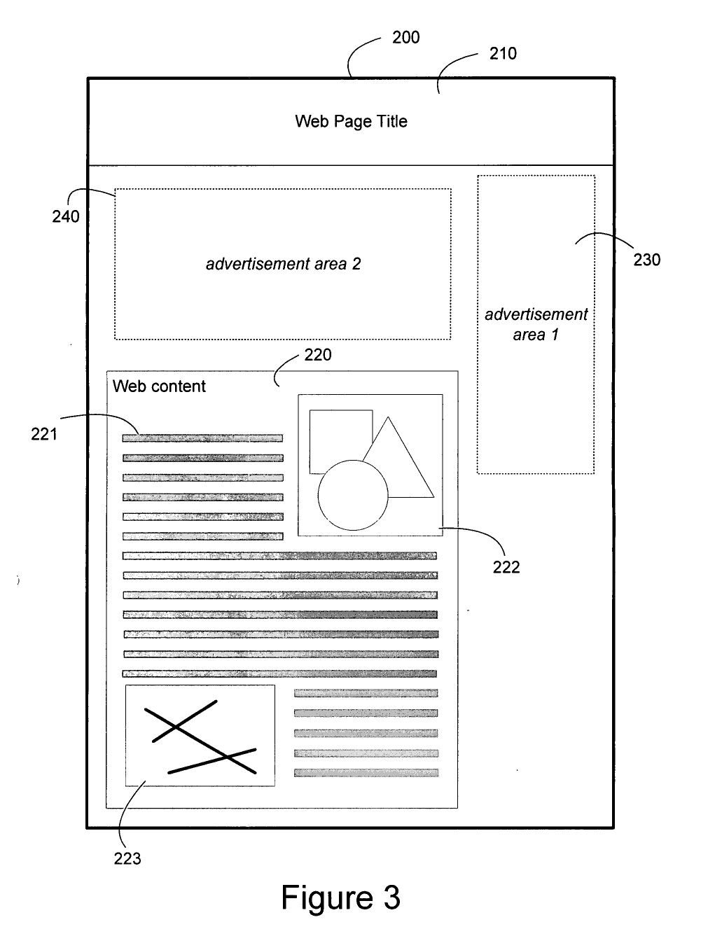

In a World Wide Web based environment, network communications occur generally within the context of the display of one or more web pages. Turning to FIG. 3, an exemplary web page 200 is shown providing areas 230 and 240 for the display of advertisements. The exemplary web page 200 could be any type of web page, including, but not limited to, search web pages, informational web pages, static web pages, blog or journal web pages, forum web pages or any other type of web page. For illustration purposes, the exemplary web page 200 is shown as an informational web page, comprising a web page title area 210 and informational content 220. Because of the hypermedia nature of web pages, the informational content 220 can comprise text 221, including links to other web pages, and images 222 and 223. Though not shown, the exemplary web page 200 could likewise comprise audio or video information as well.

While a web page, such as the exemplary web page 200 of FIG. 3, can be displayed by a browser, such as the web browser 11 of FIG. 1, as a single cohesive collection of information, the various elements of the exemplary web page can be obtained from multiple computing devices located throughout the Internet 90. In particular, the informational content 220 can be provided by a different computing device than any advertisements that may be displayed in advertisement areas 230 and 240. For example, the informational content 220 can be obtained by the web browser 11 from the publisher website 21, while advertisements that are displayed in the advertisement areas 230 and 240 can be obtained from the advertising network computing device 40, such as by accessing the advertisement database 50. In one embodiment, information in the exemplary web page 200, as provided by the publisher website 21, can instruct the web browser 11 to make an appropriate request of the advertising network computing device 40 in order to receive one or more advertisements from the advertisement database 50.

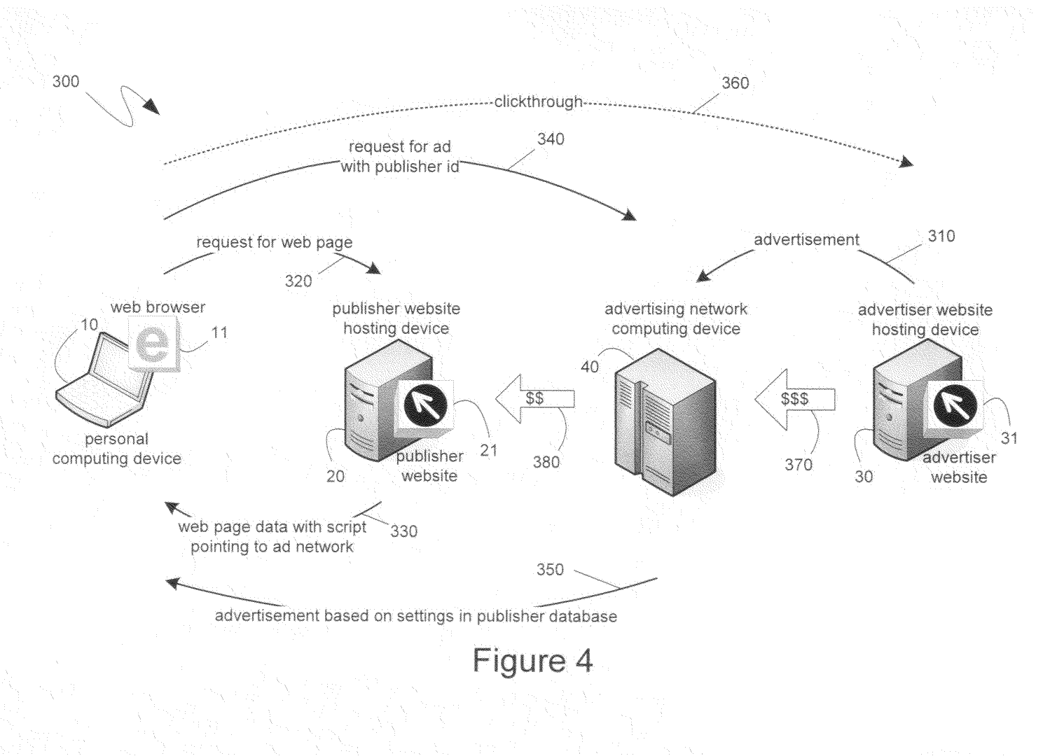

Turning to FIG. 4, a flow 300 illustrates exemplary communications that can occur among the entities of FIG. 1 to enable the display of advertisements within a web page, such as the exemplary web page 200. Initially, as indicated by communication 310, an advertiser can provide at least one advertisement to the advertising network computing device 40 for storage in the advertisement database 50. At a subsequent time, a user of the personal computing device 10 can cause the web browser 11 to make a request 320 for the data of a web page from the publisher website 21. In response, the publisher website 21 can provide, to the web browser 11, the requested web page data via communication 330. As illustrated in FIG. 4, the web page data provided by communication 330 can comprise one or more scripts that can instruct the web browser to request advertising from the advertising network computing device 40.

Upon receipt of communication 330, the web browser 11 can parse the received web page data, and in addition to displaying the various display elements contained in the data, such as the text and graphical elements 221, 222 and 223 of the exemplary web page information 220 of FIG. 3, and the web browser can also interpret and execute the embedded scripts and contact the advertising network computing device 40 to receive advertising data to be displayed in the form of one or more advertisements, such as, for example, in the advertising areas 230 and 240 of the exemplary web page 200 of FIG. 3. Thus, turning back to FIG. 4, the web browser 11 can, in response to communication 330, initiate a request 340 to the advertising network computing device 40. As illustrated, the request 340 can comprise a publisher identifier to enable the advertising network computing device 40 to select appropriate advertisements to provide in response to request 340. The selected advertisements can be provided by the advertising network computing device 40 to the web browser 11 via response communication 350.

Communications 330 and 350, therefore, comprise the necessary data for the web browser 11 to render a complete web page, such as the exemplary web page 200, comprising both web page content 220 and advertising content, such as could be displayed in areas 230 and 240. Should a visitor to the web page find a displayed advertisement intriguing, the user can click on the advertisement, causing the web browser 11 to initiate communications 360 with an advertising website hosting device 30, hosting an advertiser website 31 to which the displayed advertisement links. Such an action is known as a “click-through” and can be recorded by the web browser 11, the advertiser website 31, the publisher website 21, or any combination thereof.

In accordance with an advertising agreement between the advertiser and the advertising network, the advertiser can provide payment 370 to the advertising network for each chargeable event, such as the click-through 360. The advertising network computing device 40 can reference the publisher database 60 can determine an appropriate amount of the advertiser payment 370 that should be provided to the publisher in the form of payment 380. Traditionally, payment 380 represents a pre-defined share of the advertiser payment 370 based on the amount of chargeable events, such as click-through 360, being generated in connection with advertisements displayed on the web pages of the publisher website 21.

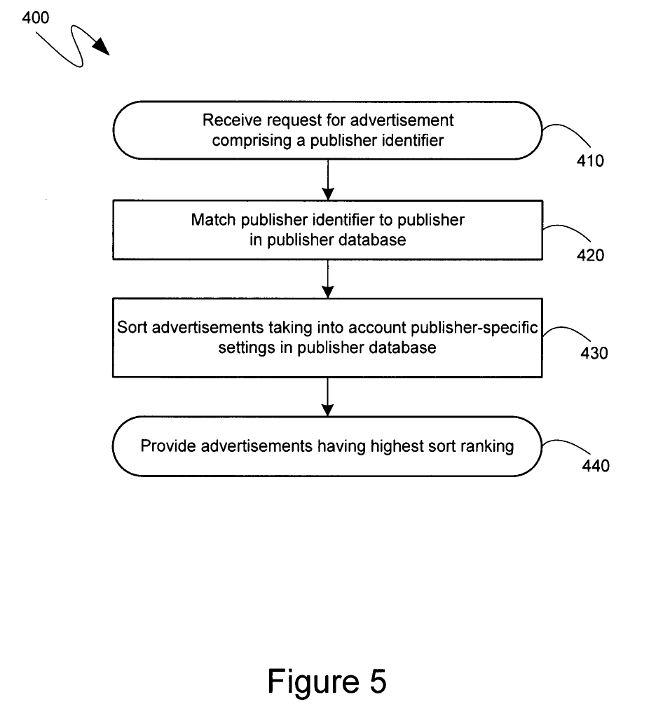

In providing the advertisement via communications 350, the advertising network computing device 40 references a publisher database 60. FIG. 5 provides a flow chart 400 illustrating an exemplary operation of the advertising network computing device. The request for the advertisement 340, including at least an identifier of the publisher, is received at step 410. Subsequently, at step 420, the advertising network computing device 40 can look up the provided publisher identifier in the publisher database 60. The publisher database 60 can comprise advertising information relevant to the publisher, such as, for example, the image size of advertisements that the publisher's web pages can accommodate, the advertisements most recently provided to that publisher's web pages, and the like.

The publisher database 60 can also comprise keywords that the publisher can associate with their web pages to enable the advertising network to select from an appropriate set of advertisements to provide for display with those web pages. For example, a publisher that publishes web sites related to home theater information can register such keywords as “LCD,” “plasma,” “television,” “speakers,” and the like. The advertising network, when selecting advertisements to provide to the publisher's web pages, can select from among those advertisements that have had matching keywords assigned to them by the advertiser submitting those advertisements. For example, an advertiser that manufactures plasma televisions can assign the keywords “plasma” and “television” to their advertisements. The advertising network could then match those keywords to the keywords used by the publisher to describe their web pages and provide such advertisements to the publisher's web pages.

Keyword matching, however, requires both the publisher and the advertiser to narrowly and accurately assign keywords that are representative of their web pages and advertisements, respectively. Unfortunately, it is not always in the advertiser's best interest to narrowly limit the keywords to their advertisements. Thus, for example, home mortgage refinancing agencies may assign keywords such as “plasma” and “television” to their advertisements under the theory that people interested in purchasing such expensive equipment may be interested in refinancing as well. However, while such refinancing agencies may regard their advertisements as relevant, the publisher, and the visitors to the publisher's web sites may not.

Consequently, in one embodiment, the publisher database 60 can comprise further information that can be used to enable a publisher to decide the relevance of one or more advertisements, even if such a decision can negatively impact the publisher's, and even the advertising network's, advertising-generated revenue. Specifically, advertisements that carry the largest bid values from the advertiser may not be relevant to the web sites published by the publisher, even if such advertisements are assigned keywords that match the web pages' keywords. In such a case, the publisher can become concerned that the continued display of irrelevant advertisements may alienate the loyal visitors of the publisher's web site. For example, if the publisher publishes a web site that reviews home theater components, continually bombarding visitors with advertisements for home mortgage refinancing may bother visitors sufficiently that many do not return. A declining number of visitors to the publisher's web site can negatively affect the publisher. For example, it can reduce the publisher's ability to secure products for review, as manufacturers no longer believe that the publisher's web site will influence many consumers to buy the reviewed product. Such a negative effect can be experienced even if a small minority of the visitors to the website actually do click on the refinancing ads, thereby generating advertising revenue for the publisher.

Consequently, a publisher may desire to have more relevant advertisements displayed on some or all of their web pages even if such more relevant advertisements can reduce the revenue the publisher receives from advertisements. The publisher database 60, maintained by the advertising network computing device 40, can, as indicated previously, comprise information relevant to a publisher's selected balance between revenue generating advertisements and relevant advertisements. In one embodiment, such information can be in the form of bid boosts applied to advertisers' bids for relevant advertisements. A bid boost, as will be explained in further detail below, can by decreasing the amount an advertiser pays, indirectly increase the advertiser's bid, thereby resulting in greater bid values for those advertisements that are relevant to the publisher.

In another embodiment, the publisher database 60 can comprise a discount value that can likewise evidence a publisher's selected balance between revenue and relevance. Unlike a bid boost, a discount can more directly impact the amount of revenue received by the advertising network from the advertiser. Specifically, a discount is directed to the share that a publisher receives from the advertising revenue received by the advertising network from the advertiser. Thus, by changing the discount, a publisher can request that a greater share of the advertising revenue remain with the advertising network, thereby increasing the advertising network's incentive to display such advertisements on the publisher's web pages.

In yet another embodiment, the publisher database 60 can comprise a rank boost value that can further evidence a publisher's selected balance between revenue and relevance. A rank boost, rather than affecting the amount of money received from an advertiser for their advertisement, instead adjusts the ranking of one or more advertisements as assigned by the advertising network. The ranking assigned to an advertisement by the advertising network directly impacts the likelihood that that advertisement will be provided in any given instance to a web browser 11 for display with the publisher's web page.

Turning back to FIG. 5, once the advertising network has used the publisher identifier, at step 420, to obtain the publisher-specific information, the advertising network can, at step 430, sort the advertisements available to the advertising network, or adjust a prior sorting of such ads. In one embodiment, the advertising network can sort, or re-sort, the advertisements based on the amount of revenue each advertisement can generate for the ad network. In an alternative embodiment, the advertising network can sort, or re-sort, the advertisements based not merely on the amount of revenue they could generate, but also on other factors such as keywords associated with the advertisement, or the display size of the advertisement.

Which ever sorting methodology is used by the advertising network, the information stored in the publisher database 60 reflecting the publisher's selected balance between revenue and relevance, can be taken into account when performing the sorting. For example, if the publisher had set a rank boost for the advertisements of a particular advertiser, then those ads would be ranked higher by the advertising network at step 430 than they otherwise would have been, as specified by the rank boost. Similarly, if the publisher had specified a discount for a certain category of advertisement, the increased potential revenue to the advertiser network from such a discount would cause those advertisements to be ranked higher than they otherwise would have been. Having ranked the advertisements at step 430, the advertising network computing device 40 can then, at step 440, provide to the web browser 11, via communications 350, the advertisements having the highest rank.

To enable a publisher to meaningfully balance advertising revenue generation and visitor retention by avoiding the display of irrelevant advertisements, an advertising network can provide, to the publisher, information relevant to the publisher's revenue versus relevance determination. In one embodiment, such information can include historical information regarding the previous advertisements displayed on the publisher's web pages, such as, for example, the type of ad displayed, whether a visitor clicked on the ad, the revenue generated by the ad, any keywords associated with the ad, and other like information. Such historical information can be used as the basis for models by which the advertising network could offer predictive services to the publisher. For example, if the click-through rate from the publisher's web pages was low when those web pages displayed refinancing advertisements, the advertising network could predict that the loss of revenue that would be caused by deemphasizing such advertisements would be minimal. Indeed, because much of the relevant information may actually be maintained by the publisher themselves, the value provided by the advertising network could be in the form of predictive models that the advertising network can hone over multiple publishers and a greater set of data than would be available to any one publisher.

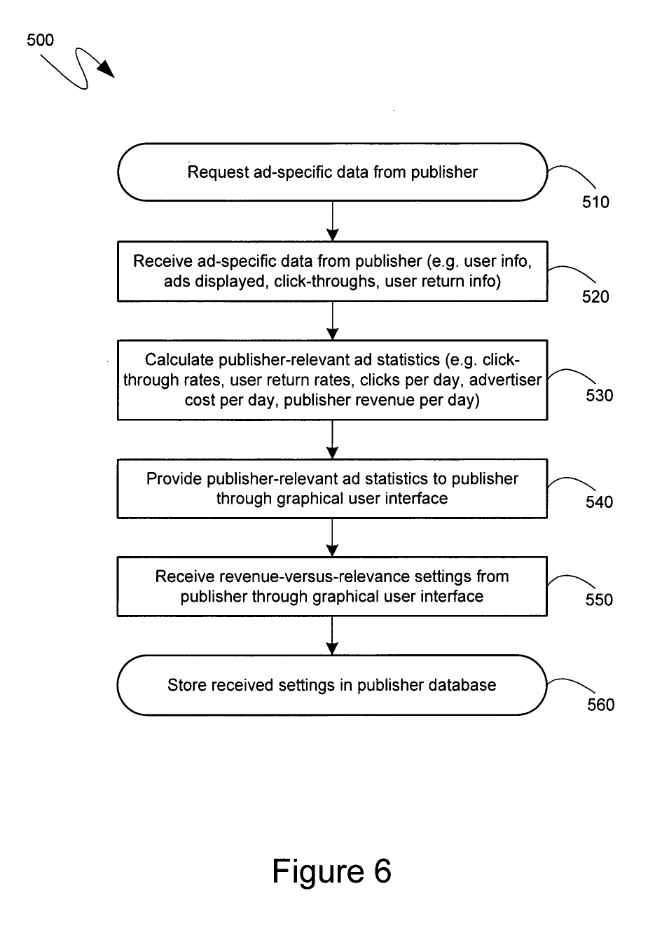

Turning to FIG. 6, flow chart 500 illustrates an exemplary series of steps for obtaining, from the publisher, settings reflecting the balance, desired by the publisher, between revenue generating advertisements and relevant advertisements that can help maintain a loyal visitor base. Initially, because, as indicated, the publisher themselves is often in the best position to collect information relevant to the publisher's revenue versus relevance decision, the advertising network can request, at step 510, any advertisement-specific data that the publisher may have. Such data can comprise an identifier of the advertisement displayed and an indication of whether the advertisement generated a click-through. The data can also comprise user data, such as user identifying information and whether the user returned to the website after the visit where the identified advertisement was displayed.

The requested advertisement-specific data can be received by the advertising network computing device 40 at step 520, and at step 530, the ad network computing device can calculate statistics that can be useful for the publisher in determining how to balance relevant advertisements against revenue generating advertisements. For example, the advertising network computing device 40 can calculate the publisher's revenue per day and the return rates of the visitors to the publisher's web pages, thereby enabling the publisher to directly compare advertising revenue generation with the effect such advertisements may be having on any loyal visitor base that the publisher may have for their web pages. Additional statistics that can be calculated by the advertising network computing device 40 and provided to the publisher include click-through rates and clicks per day. Such statistics can be useful when modeling the effect of any changes the publisher may seek to make. For example, if the publisher sought to sacrifice revenue to ensure that more relevant advertisements were displayed on the publisher's web pages, a low-click through rate could be used by the advertising network computing device 40 to model a gradual decrease in publisher revenue in response to such a decision by the publisher.

At step 540 of FIG. 6, the publisher-relevant statistics can be provided to the publisher through a graphical user interface. In one embodiment, for example, a publisher could log onto the advertising network computing device 40 and be presented by the interface of step 540. Such an interface could also be used to provide a mechanism by which the publisher could indicate their preference of more relevant advertisements or advertisements that generate greater revenue. The publisher's input regarding advertising relevance and revenue can be received at step 550 and subsequently stored in the publisher database 60 at step 560. In one embodiment, the settings stored in the publisher database 60 at step 560 can comprise multiple bid boosts, discounts and rank boosts that were each individually set by the publisher at step 550. In another embodiment, the publisher can merely provide broad guidance at step 550 and the advertising network computing device 40 can, based on the provided guidance, determine appropriate bid boosts, discounts and rank boosts and store them in the publisher database 60 at step 560.

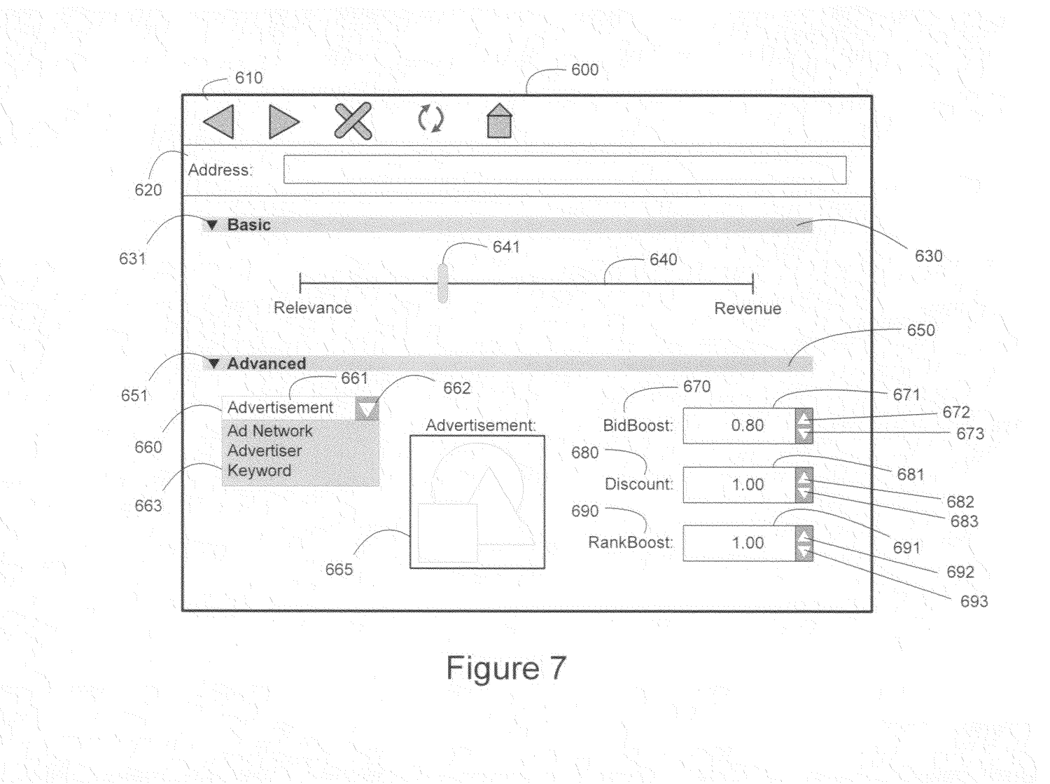

As indicated, the publisher's input regarding advertising relevant and revenue can be received by the advertising network computing device 40 through a user interface presented to publishers that direct their web pages to receive advertisements from the ad network. Turning to FIG. 7, an example of such a user interface is show in the form of a web page displayed as part of a web browser screen 600. The web browser screen 600 can include a command bar 610, displaying graphical icons representing common browsing commands, and an address bar 620 for receiving the location of the document to be displayed.

The exemplary user interface of FIG. 7 comprises both a “basic” section 630 and an “advanced” section 650, each of which can be displayed or hidden via controls 631 and 651, respectively. Basic section 630 can comprise a simple interface for enabling the publisher to exert some control over the relevance of the advertisements displayed on that publisher's web sites. In the exemplary interface illustrated in FIG. 7, such a simple interface can be a slider bar mechanism 640, whereby a slider 641 is used to indicate a relative weighting between maximizing the revenue generated by advertising and maximizing the relevance of the displayed advertisements, irrespective of the revenue generation potential of such relevant ads. For example, a publisher could indicate a desire to display more relevant advertising, irrespective of the impact on ad revenue generation, by dragging the slider 641 closer to the “relevance” endpoint of the slider bar 640. Likewise, a publisher could indicate a desire to display advertising with a greater revenue generation potential by dragging the slider 641 closer to the “revenue” endpoint of the slider bar 640.

The specific settings represented by the relative location of the slider 641 can be calculated by the advertising network computing device 40 and stored in the publisher database 60. In one embodiment, such specific settings can comprise specific bid boosts, discounts, or rank boosts on advertisements that are deemed more relevant to the publisher's web pages. Such relevance can be determined by any one or more factors, including the advertiser, key words associated with the advertisements, and the products or services advertised. For example, if the publisher publishes web sites directed to home theater enthusiasts, advertisements from known home theater manufacturers can have a bid boost, rank boost, or discount applied automatically in response to the publisher's input via the slider 641. Similarly, advertisements whose key words, as assigned by the advertiser, for example, indicate an association with home theater technologies can likewise have a bid boost, rank boost, or discount applied automatically when the publisher moves the slider 641 to indicate a preference of more relevant advertisements.

While the basic section 630 of the exemplary interface shown in FIG. 7 enables a publisher to influence the advertisements that are displayed on their web sites, specifically enabling the publisher to sacrifice revenue for more relevant ads, or vice-versa, the advertising network may choose to offer the publisher the opportunity to provide more detailed input regarding the advertisements displayed on the publisher's web sites. To that end, an advanced section 650 is likewise shown in the exemplary interface of FIG. 7. Using such an advanced section 650, the publisher can be provided the opportunity to individually set the bid boost, the discount, the rank boost, or any combination thereof. Furthermore, such factors could be set individually for each advertisement, all of the advertisements from a particular advertiser, all of the advertisements that are associated with a common keyword, or collection of key words, or even all of the advertisements from a particular advertising network, assuming the ad network providing the interface shares advertisements with other ad networks.

In one embodiment, the advanced section 650 can be used in combination with the basic section 630. More specifically, the advanced section 650 can be used to individually set factors, such as the bid boost, rank boost and discount, for a specific set of advertisements. For those advertisements to which the settings of the advanced section 650 are not applicable, the advertising network computing device 40 can automatically assign factors, such as the bid boost, rank boost and discount, in accordance with the balance between relevance and revenue indicated by the slider 641 of the basic section 630. Such an automatic assignment can be optimized in the manner described in detail above.

Within the advanced section 650 illustrated in FIG. 7, the publisher can be presented with a selection 660 that enables the publisher to choose whether the entered settings apply to a specific advertisement, a specific advertising network, a specific advertiser, or a specific keyword or collection of keywords. These categories can be, for example, exposed through a drop down menu 663 that lists the available options, and such a menu can be displayed via a drop-down menu selector 662. Once a category is selected, the specifics of such a category can be displayed in the area 665. Thus, if the advertisement category is selected via selection 660, as illustrated in FIG. 7, area 665 can display a graphical representation of the specific advertisement to which the entered settings will be applied. Alternatively, if the keyword category was selected via selection 660, area 665 could display the one or more keywords to which the entered settings will be applied.

The settings, which can be exposed to the publisher through an interface such as that shown in FIG. 7, can comprise a bid boost 670, a discount 680, and a rank boost 690. In each case, the relevant setting can be expressed in numerical form through a display 671, 681 or 691, respectively. In the case of bid boost 670, the numerical value in display 671 can represent a discount to be applied to the bid provided by an advertiser for an advertisement to which the bid boost will apply. For example, using the amount illustrated in FIG. 7, a bid boost value of 0.8 will “boost” the advertiser's bid by 0.8; in other words discount it by 20%. Thus, if, for example, an advertiser had bid a dollar for each click-through, the actual invoiced amount for a click-through on an advertisement to which such a bid boost applied would only be 80 cents.

Similarly, the discount 680 can be expressed in numerical form, such as in display 681. The numerical value of the discount 680 can represent a reduction to the publisher's share of the payment that is received by the advertising network from the advertiser for the advertisement to which the discount applies. Thus, a discount value of 0.7 indicates that the publisher has agreed to receive only 70% of their allotted share of the advertiser's payment, thereby leaving the remaining 30% for the advertising network. This 30% would be in addition to the advertising network's original allotted share of the advertiser's payment. Thus, if the advertising network traditionally kept 10% of the advertiser's payment for itself, and sent the remaining 90% to the publisher, a discount of value of 0.7 would leave 30% of the publisher's 90% share for the ad network. Expressed differently, for an advertisement to which a discount value of 0.7 applies, the advertising network's share is increased from 10% to 37% (10%+30% of 90%) of the original advertiser's payment.

Unlike the bid boost and discount factors, a rank boost does not directly impact any monetary amount. Instead, the rank boost 690 can be applied to the advertising network's internal ranking of advertisements for a particular web page. In one embodiment, the value of the rank boost 690, as shown in display 691, can represent the number of rankings by which an affected advertisement can be increased or decreased. Thus, a rank boost of 4 could result in an advertisement originally ranked 7^{th} in a ranked listing being moved up to the 3^{rd} position. In another embodiment, advertisements can be ranked based on a combined “score” assigned by the advertising network for internal ranking purposes, with each element of the score reflecting some aspect of the advertisement that the ad network deems important. In such a case, the rank boost 690 can be represented in the form of a factor, shown in display 691, with which the score can be multiplied to calculate a new, “boosted” score, which can then be used for ranking purposes. Thus, for example, if the rank boost 690 was 1.3, an advertisement previously ranked based on an internal score of 50 would, after application of the rank boost, be ranked based on an internal score of 65, thereby likely increasing its ranking.

Each of the bid boost, discount, and rank boost values can be, alone, or in combination, offered to the publisher for modification through an interface such as that illustrated in FIG. 7. For example, the publisher can be presented with controls, shown in FIG. 7 as up arrow 672 and down arrow 673 with which to adjust the bid boost 670 up or down, respectively. Similarly, the publisher can be presented with controls, shown in FIG. 7 as up arrows 682 and 692 and down arrows 683 and 693, with which to adjust the discount 680 and the rank boost 690, respectively. If the advertising network does not wish to provide, to a publisher, the ability to change any one or more of the bid boost, discount or rank boost, the ad network can simply disable arrows 672, 673, 682, 683, 692, or 693, as appropriate, or, alternatively, not even show the factor in the first place. Initially, prior to any modification by a publisher, the bid boost and discount can have a default value of 1.0, representing a neutral value that does not effect the advertiser's original bid. The rank boost can likewise have a default value that provides no effect on the advertising network's rankings, which, depending on the mechanism used to implement the rank boost, can be a value of 1.0 or 0.0.

Although not explicitly shown in the exemplary user interface of FIG. 7, the advertising network can, as described in detail above, provide predictive data to the publisher to aid the publisher in making the selections enabled by the interface shown in FIG. 7. For example, as the publisher adjusts the slider 641, or changes the values of the bid boost 670, the discount 680, or the rank boost 690, the publisher can be presented with an updated estimate of how such a change may impact factors that are of interest to the publisher, such as the publisher's advertising-generated revenue, or the number of visitors to the publisher's web sites who can be expected to return with a specific period of time. Such information can be provided through an interface that can be linked to the interface shown in FIG. 7, enabling the publisher to easily transition between them.

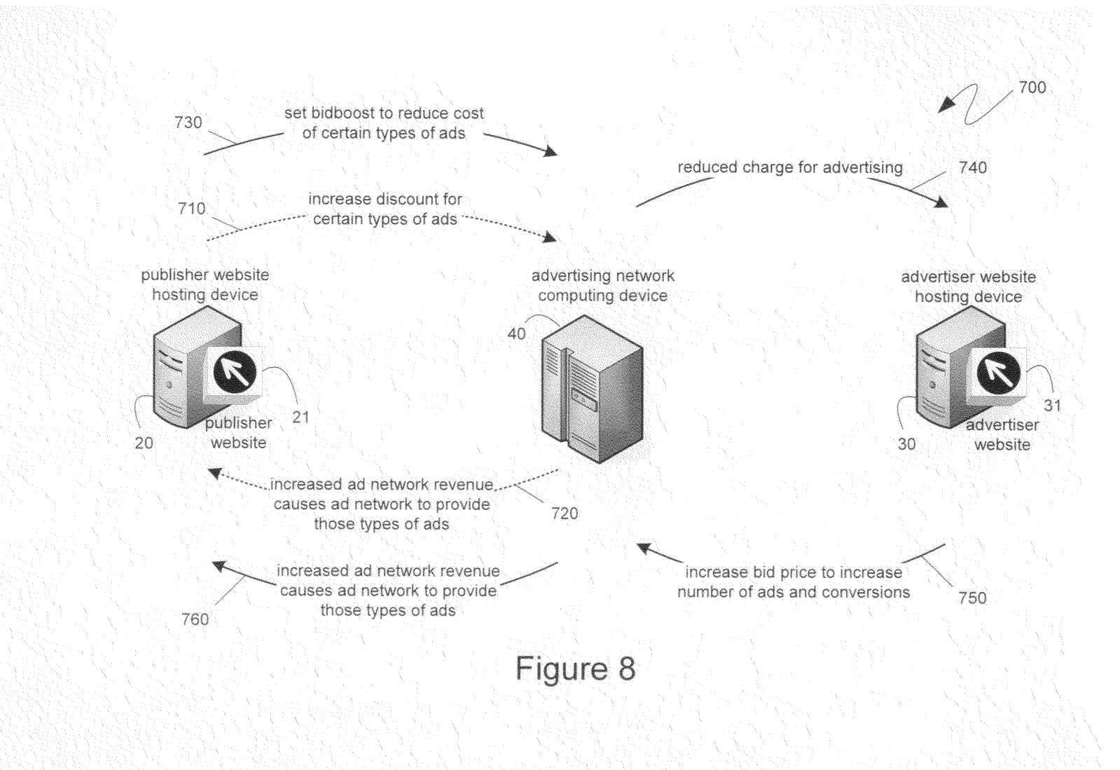

Among the mechanisms provided to the publisher with which to adjust the relevance of advertisements displayed on the publisher's web pages, the discount 680 and the bid boost 670, unlike the rank boost 690, provide no direct impact on the advertisement's ranking. Instead, for both the bid boost 670 and the discount 680, the revenue to the advertising network is increased. This revenue increase is, in turn, expected to raise the targeted advertisements' ranking. Turning to FIG. 8, the overall operation of the bid boost and discount mechanisms is described with reference to flow diagram 700.

The discount mechanism operates in a somewhat simpler manner and its operation is illustrated via messages 710 and 720. Specifically, as indicated by message 710, the publisher can initially apply a discount to one or more advertisements, such as through the exemplary user interface of FIG. 7. Such a discount, as explained in detail above, reduces the share of the advertiser's payment to the publisher for the advertisements to which it is applied, thereby increasing the advertising network's share. Consequently, as illustrated by message 720, the increased advertising network revenue can result in the presentation of more of the targeted advertisements with the publisher's web pages.

The bid boost mechanism operates in a slightly more complex manner, and its operation is illustrated by messages 730, 740, 750 and 760. Initially, as indicated via communication 730, the publisher can apply a bid boost to one or more advertisements, such as through the exemplary user interface of FIG. 7. The bid boost of communication 730 can, as explained in detail above, act as a discount to reduce the cost, to the advertiser, of the advertisements to which it is applied. Thus, the invoice, sent by the advertising network to the advertiser, via communication 740, reflects a reduced charge for the advertisements to which the publisher's bid boost applied.

Generally advertisers establish a specific advertising budget, and seek to achieve as much as they can with the set budget. One measure by which an advertiser can measure the impact of their advertisements is by monitoring the cost-per-click-through or the cost-per-conversion of an advertisement. To accomplish more with a given advertising budget, a rational advertiser will direct more of their budget towards advertisements that generate more click-throughs, or more conversions, per dollar spent. By reducing the advertiser's cost through the bid boost mechanism, the publisher increases the advertiser's cost-per-click-through and cost-per-conversion for the advertisements to which the bid boost is directed. The publisher, therefore, will direct more of their advertising budget towards such advertisements by increasing their bid, as represented by communication 750. An increase in the advertiser's bid results in an attendant increase in the advertising network's revenue from the advertisements to which the bid boost was directed. Consequently, as illustrated by communication 760, the advertising network can provide those advertisements more often to the publisher's web sites. The bid boost, therefore, provides a mechanism by which the publisher can influence the advertisements displayed with its web pages while minimizing the negative impact on both its advertising revenue and on the advertising network's revenue.

As can be seen from the above descriptions, an advertising network can provide mechanisms, including bid boost, discount and rank boost, by which a publisher can request more relevant advertisements for display with its web pages, even if such a request can result in a negative impact on the publisher's, and even the advertising network's, advertising-generated revenue. In view of the many possible variations of the subject matter described herein, we claim as our invention all such embodiments as may come within the scope of the following claims and equivalents thereto.

We claim:

1. One or more computer-readable media comprising computer-executable instructions for enabling a publisher to influence advertisements displayed on the publisher's publications, the computer-executable instructions performing steps comprising:
receiving, from the publisher, input regarding an adjustment factor applicable to one or more selected advertisements, the adjustment factor comprising at least one of: a bid boost factor applied to an advertiser's bid for the one or more selected advertisements, a discount factor applied to a publisher's share of income from the one or more selected advertisements, and a rank boost factor applied to the one or more selected advertisements to modify a ranking of potential advertisements for the publisher's publications; and
providing, for display on one of the publisher's publications, at least one advertisement due to the adjustment factor.

2. The computer-readable media of claim 1, wherein the one or more selected advertisements are selected based on a common advertiser.

3. The computer-readable media of claim 1, wherein the one or more selected advertisements are selected based on common keywords assigned to the one or more selected advertisements.

4. The computer-readable media of claim 1, wherein the input regarding the adjustment factor comprise a single revenue-versus-relevance selection, and wherein the one or more selected advertisements comprise all advertisements to be displayed on the publisher's publications.

5. The computer-readable media of claim 4 comprising further computer-executable instructions performing steps comprising: setting optimized individual adjustment factors based, at least in part, on the revenue-versus-relevance selection.

6. The computer-readable media of claim 4, wherein the input regarding the adjustment factor further comprise individual adjustment factor settings that trump the single revenue-versus-relevance selection for at least one of the one or more selected advertisements.

7. The computer-readable media of claim 1, wherein the receiving occurs via a user interface comprising a prediction of publisher statistics if the input regarding the adjustment factor are applied.

8. The computer-readable media of claim 1 comprising further computer-executable instructions performing steps comprising: obtaining, from the publisher, advertising-related statistics relevant to advertisements previously displayed on the publisher's publications.

9. A user interface enabling a publisher to influence advertisements displayed on the publisher's publications, the user interface comprising:
a first input mechanism for accepting a single revenue-versus-relevance selection applicable to all advertisements to be displayed;
a second input mechanism for accepting an adjustment factor applicable to one or more selected advertisements, the adjustment factor comprising at least one of: a bid boost factor applied to an advertiser's bid for the one or more selected advertisements, a discount factor applied to a publisher's share of income from the one or more selected advertisements, and a rank boost factor applied to the one or more selected advertisements to modify a ranking of potential advertisements for the publisher's publications; and
a third input mechanism for selecting the one or more selected advertisements.

10. The user interface of claim 9 further comprising a predictive display for presenting predictions of publisher statistics based on application of settings received the first, second and third input mechanisms.

11. The user interface of claim 10, wherein the publisher statistics comprises advertising-generated revenue for the publisher.

12. The user interface of claim 10, wherein the publisher statistics comprises visitor return rates for the publisher's publications.

13. The user interface of claim 9, wherein the adjustment factor applicable to the one or more selected advertisements trumps the single revenue-versus-relevance selection with respect to the one or more selected advertisements.

14. One or more computer-readable media comprising computer-executable instructions for selecting one or more advertisements for display on a publisher's publication, the computer-executable instructions directed to steps comprising:
sorting potential advertisements based, at least in part, on an income generation ability for each of the potential advertisements, the income generation ability accounting for a discount specified by the publisher, the discount reducing a publisher's share of any income from an advertisement to which the discount applies;
adjusting the sorting to account for a rank boost that modifies a sort order of an advertisement to which the rank boost applies; and
requesting payment according to one or more advertisers' bids, the requested payment adjusted by a bid boost applied to a bid associated with an advertisement to which a bid boost applies.

15. The computer-readable media of claim 14 comprising further computer-executable instructions performing steps comprising: receiving bid boost, discount and rank boost values from the publisher.

16. The computer-readable media of claim 14 comprising further computer-executable instructions performing steps comprising: notifying the publisher of an improper entry if the received bid boost, discount or rank boost values exceed predetermined limits.

17. The computer-readable media of claim 14 comprising further computer-executable instructions performing steps comprising: receiving, from the publisher, a single revenue-versus-relevance selection; and calculating optimal bid boost, discount and rank boost values based on the single revenue-versus-relevance selection.

18. The computer-readable media of claim 14 comprising further computer-executable instructions performing steps comprising: presenting an interface, to the publisher, for receiving publisher input regarding the bid boost, discount and rank boost; predicting publisher statistics based on the received publisher input; and updating the interface to display the predicted publisher statistics.

19. The computer-readable media of claim 14 comprising further computer-executable instructions performing steps comprising: selecting the potential advertisements based on keywords.
